(19) United States
(12) Patent Application Publication
(10) Pub. No.: US 2014/0182309 A1
(43) Pub. Date: Jul. 3, 2014

(54) GEARED GAS TURBINE ENGINE EXHAUST NOZZLE WITH CHEVRONS

(71) Applicant: UNITED TECHNOLOGIES CORPORATION, Hartford, CT (US)

(72) Inventor: Amr Ali, South Windsor, CT (US)

(73) Assignee: UNITED TECHNOLOGIES CORPORATION, Hartford, CT (US)

(21) Appl. No.: 13/729,163

(22) Filed: Dec. 28, 2012

(51) Int. Cl. F02C 7/00

(52) U.S. Cl. CPC F02C 7/00
USPC 60/805

(57) ABSTRACT

A gas turbine engine includes a core engine having a compressor section fluidly connected to a combustor section that is also fluidly connected to a turbine section. A core nacelle surrounds the core engine and includes a core nozzle. A fan is connected to the compressor section and is arranged upstream from the core engine. A gear train interconnects the turbine section to the fan. A fan nacelle at least partially surrounds the core nacelle and includes a fan nozzle. The fan is disposed in the fan nacelle. At least one of the fan nozzle and core nozzle includes circumferentially fixed chevrons that provide a fixed exit area throughout engine operation.

### BACKGROUND

This disclosure relates to a geared gas turbine engine. More particularly, the disclosure relates to an exhaust configuration for use with a geared gas turbine engine.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

The generation of noise from turbulent gas turbine engine exhausts is of significant practical interest for low and moderate bypass ratio engines used in subsonic civil transports. The gas turbine engine exhaust noise is one component of overall engine noise, and is particularly important at take-off and cutback conditions. For high bypass ratio engines, the gas turbine engine noise contribution is reduced, for example, by using a geared gas turbine engine, but noise is still a factor especially with continually tightening of noise restrictions.

### SUMMARY

In one exemplary embodiment, a gas turbine engine includes a core engine having a compressor section fluidly connected to a combustor section that is also fluidly connected to a turbine section. A core nacelle surrounds the core engine and includes a core nozzle. A fan is connected to the compressor section and is arranged upstream from the core engine. A gear train interconnects the turbine section to the fan. A fan nacelle at least partially surrounds the core nacelle and includes a fan nozzle. The fan is disposed in the fan nacelle. At least one of the fan nozzle and core nozzle includes circumferentially fixed chevrons that provide a fixed exit area throughout engine operation.

In a further embodiment of any of the above, the compressor section includes a high pressure compressor and a low pressure compressor. The turbine section includes a high pressure turbine and a low pressure turbine. The high pressure turbine is coupled to the high pressure compressor via a shaft.

In a further embodiment of any of the above, the low pressure turbine has a pressure ratio that is greater than about 5.

In a further embodiment of any of the above, the gas turbine engine is a high bypass geared aircraft engine having a bypass ratio of greater than about six (6).

In a further embodiment of any of the above, the gas turbine engine includes a low Fan Pressure Ratio of less than about 1.45.

In a further embodiment of any of the above, the gear train provides a gear reduction ratio of greater than about 2.3 to the fan.

In a further embodiment of any of the above, the chevrons are provided on the fan nacelle.

In a further embodiment of any of the above, the chevrons provide a first set of chevrons and a second set of chevrons are provided on the core nacelle.

In a further embodiment of any of the above, the chevrons are provided on the core nacelle.

In a further embodiment of any of the above, the chevrons provide a first set of chevrons and a second set of chevrons are provided on the fan nacelle.

In a further embodiment of any of the above, the gas turbine engine includes a tail cone arranged downstream from the core engine and radially inward of the core nacelle.

### BRIEF DESCRIPTION OF THE DRAWINGS

The disclosure can be further understood by reference to the following detailed description when considered in connection with the accompanying drawings wherein:

FIG. 1 schematically illustrates a geared gas turbine engine embodiment.

FIG. 2 is one example exhaust configuration for the geared gas turbine engine of FIG. 1.

FIG. 3 is another example exhaust configuration for the geared gas turbine engine of FIG. 1.

FIG. 4 is still another example exhaust configuration for the geared gas turbine engine of FIG. 1.

### DETAILED DESCRIPTION

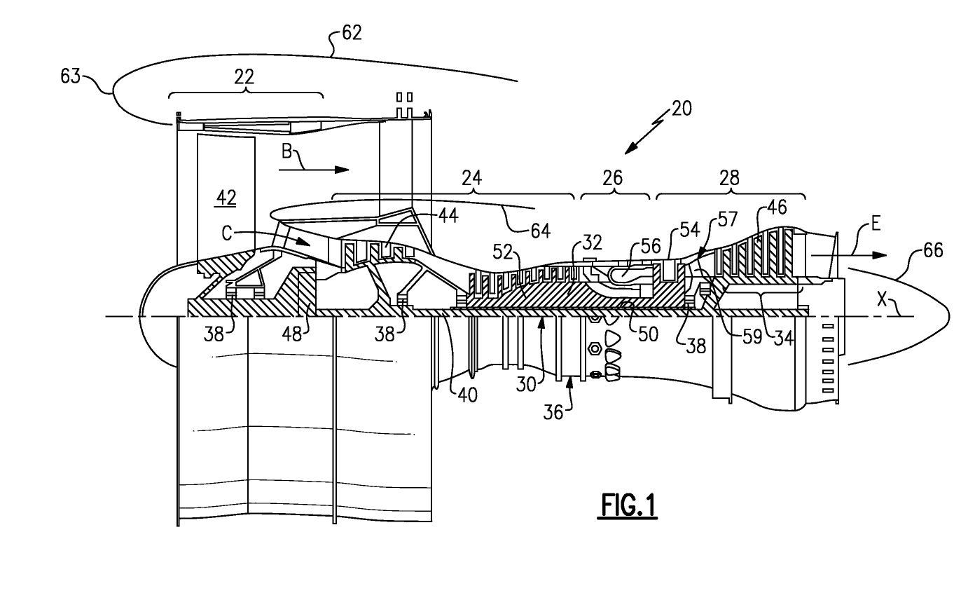

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis X.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about five (5). The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 57 includes vanes 59, which are in the core airflow path and function as an inlet guide vane for the low pressure turbine 46. Utilizing the vane 59 of the mid-turbine frame 57 as the inlet guide vane for low pressure turbine 46 decreases the length of the low pressure turbine 46 without increasing the axial length of the mid-turbine frame 57. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7° R)] ^{0.5}. The “Low corrected fan tip speed”, as disclosed herein according to one non-limiting embodiment, is less than about 1150 ft/second.

The compressor section 24, the combustor section 26 and the turbine section 28 comprise a core engine arranged within a core nacelle 64. A tail cone 66 is arranged downstream from the core engine and is radially inward of the core nacelle 64. An exhaust flow E exits the core engine between the core nacelle 64 and the tail cone 66.

A fan nacelle 62 at least partially surrounds the core nacelle 64. The fan 42 is disposed in the fan nacelle 62 upstream from the core engine and core nacelle 64. The fan nacelle 62 provides an inlet 63 that receives airflow into the engine 20. The bypass flow B exits between the fan nacelle 62 and core nacelle 64.

The geared gas turbine engine includes an exhaust configuration having one or more noise reduction features, shown at 60, 160, 260 respectively in FIGS. 2-4. The exhaust configuration is provided by chevrons that manipulate the bypass flow B and exhaust flow E to reduce the noise caused by these intermingling flows. Although the use of the geared architecture 48 greatly reduces the overall noise of the engine 20, it is desirable to further reduce engine noise.

A geared gas turbine engine has a unique noise signature that is not present in non-geared gas turbine engine. More specifically, unlike conventional two spool gas turbine engines in which the fan rotates at the same speed as the low pressure compressor and low pressure turbine, the gear of the exemplary embodiments herein enables the fan to rotate slower while at the same time enabling the low pressure compressor and the low pressure turbine to rotate faster. Thus, the exhaust configuration is tuned to reduce the type of noise unique to a geared gas turbine engine.

Referring to FIG. 2, fan nacelle 62 of the engine 20 includes a fan nozzle 68, and the core nacelle 64 includes a core nozzle 70. At least one of the fan nozzle 68 and core nozzle 70 includes circumferentially fixed chevrons providing a fixed exit area throughout engine operation. In the example in FIG. 2, the core nozzle 70 includes a set of chevrons 72, which are tuned to reduce the noise signature of the engine 20. The chevrons 72 may be of any suitable shape for the application.

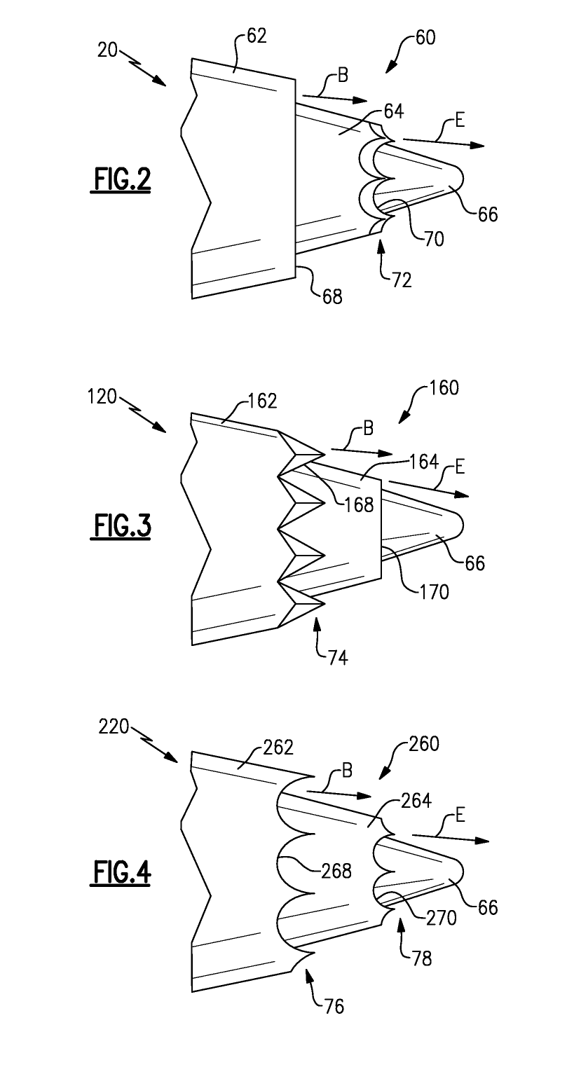

Referring to FIG. 3, fan nacelle 162 of the engine 120 includes a fan nozzle 168, and the core nacelle 164 includes a core nozzle 170. The fan nozzle 168 includes a first set of chevrons 74, which are tuned to reduce the noise signature of the engine 120. The chevrons 74 are circumferentially fixed to provide a fixed exit area throughout engine operation in the example.

Referring to FIG. 4, fan nacelle 262 of the engine 220 includes a fan nozzle 268, and the core nacelle 264 includes a core nozzle 270. The fan nozzle 268 and core nozzle 270 respectively include first and second sets of chevrons 76, 78, which provide a circumferentially fixed exit area throughout engine operation. The chevrons 76, 78 are tuned to reduce the noise signature of the engine 20. The chevrons 72 may be of any suitable shape for the application

Although example embodiments have been disclosed, a worker of ordinary skill in this art would recognize that certain modifications would come within the scope of the claims. For example, different type and arrangements of turbulence promoting features may be used. For that and other reasons, the following claims should be studied to determine their true scope and content.

What is claimed is:

1. A gas turbine engine comprising:
a core engine having a compressor section fluidly connected to a combustor section that is also fluidly connected to a turbine section;
a core nacelle surrounding the core engine and including a core nozzle;
a fan connected to the compressor section and arranged upstream from the core engine;
a gear train interconnecting the turbine section to the fan;
a fan nacelle at least partially surrounding the core nacelle and including a fan nozzle, the fan disposed in the fan nacelle; and
at least one of the fan nozzle and core nozzle includes circumferentially fixed chevrons providing a fixed exit area throughout engine operation.

2. The gas turbine engine according to claim 1, wherein the compressor section comprising a high pressure compressor and a low pressure compressor, and the turbine section comprising a high pressure turbine and a low pressure turbine, wherein the high pressure turbine is coupled to the high pressure compressor via a shaft.

3. The gas turbine engine according to claim 2, wherein the low pressure turbine has a pressure ratio that is greater than about 5.

4. The gas turbine engine according to claim 1, wherein the gas turbine engine is a high bypass geared aircraft engine having a bypass ratio of greater than about six (6).

5. The gas turbine engine according to claim 1, wherein the gas turbine engine includes a low Fan Pressure Ratio of less than about 1.45.

6. The gas turbine engine according to claim 1, wherein the gear train provides a gear reduction ratio of greater than about 2.3 to the fan.

7. The gas turbine engine according to claim 1, wherein the chevrons are provided on the fan nacelle.

8. The gas turbine engine according to claim 7, wherein the chevrons provide a first set of chevrons, and a second set of chevrons are provided on the core nacelle.

9. The gas turbine engine according to claim 1, wherein the chevrons are provided on the core nacelle.

10. The gas turbine engine according to claim 9, wherein the chevrons provide a first set of chevrons, and a second set of chevrons are provided on the fan nacelle.

11. The gas turbine engine according to claim 1, comprising a tail cone arranged downstream from the core engine and radially inward of the core nacelle.
